(19) United States
(12) Patent Application Publication
(10) Pub. No.: US 2001/0013707 A1
(43) Pub. Date: Aug. 16, 2001

(54) Y-BEND

(76) Inventor: RICHARD L. LINDWALL, ATLANTA, GA (US)

Correspondence Address: DR RICHARD L LINDWALL, 17 Lakes Edge Drive, Smyrna, GA, 30080, US

(21) Appl. No.: 09/309,638

(22) Filed: May 11, 1999

(51) Int. Cl. B65G 7/12

(52) U.S. Cl. 294/15

(57) ABSTRACT

The “Y-Bend”. A design for an ergonomically correct manual lifting device designed to reduce lower lumbar back injury while elevating heavy objects such as desks, filing cabinets, furniture and shipping boxes. While keeping the spine upright, an object can be elevated by “walking” the hands down the rungs of the Y-Bend causing the load-bearing lower “lip” of the Y-Bend to become elevated. Unimpaired workers applying accepted principles of maximum utilization of the human anatomical structure are placed at substantially reduced risk of lower back injury while lifting with this device.

### CROSS REFERENCE TO RELATED APPLICATIONS

“Not Applicable”

### STATEMENT REGARDING FEDERALLY SOPONSORED RESEARCH OR DEVELOPMENT

“Not Applicable”

### REFERENCE TO A MICROFICHE APPENDIX

“Not Applicable”

### BACKGROUND OF THE INVENTION

There exists a widespread problem of lower back injury caused by workers manually lifting heavy objects. My patent search under related headings such as section 254 Lifts and section 266 Hoists revealed only powered devices. No comparable manual device.

### BRIEF SUMMARY OF THE INVENTION

The Y-Bend manual lifting device was developed to substantially reduce the risk of lower back injury caused by industry workers manually lifting heavy objects. Specifically, moving company workers often move heavy objects in areas such as offices and homes which are frequently inaccessible to mechanical aids such as fork trucks. When properly utilized the Y-Bend will permit the manual elevation, lifting and transporting of heavy loads without bending the lower spine. The risk of lower back injury is thereby substantially reduced.

### BRIEF DESCRIPTION OF THE SEVERAL VIEWS OF THE DRAWING

FIG. 1 is an isometric drawing of the Y-Bend Manual Lifting Device First Embodiment.

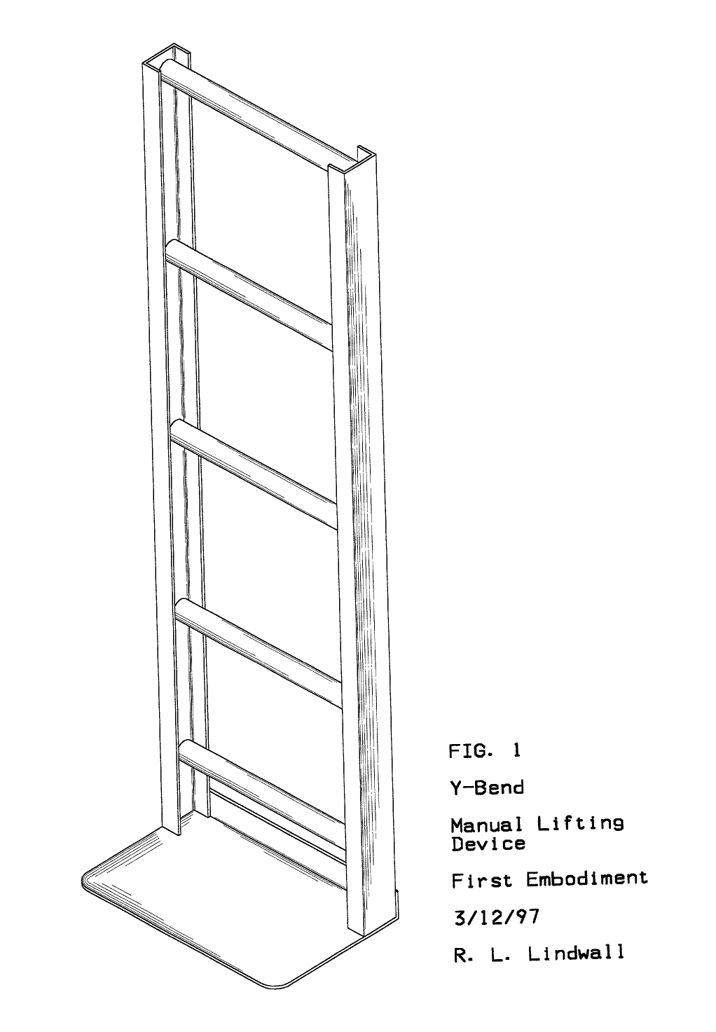

FIG. 2 is an isometric drawing of the Y-Bend Manual Lifting Device Second Embodiment.

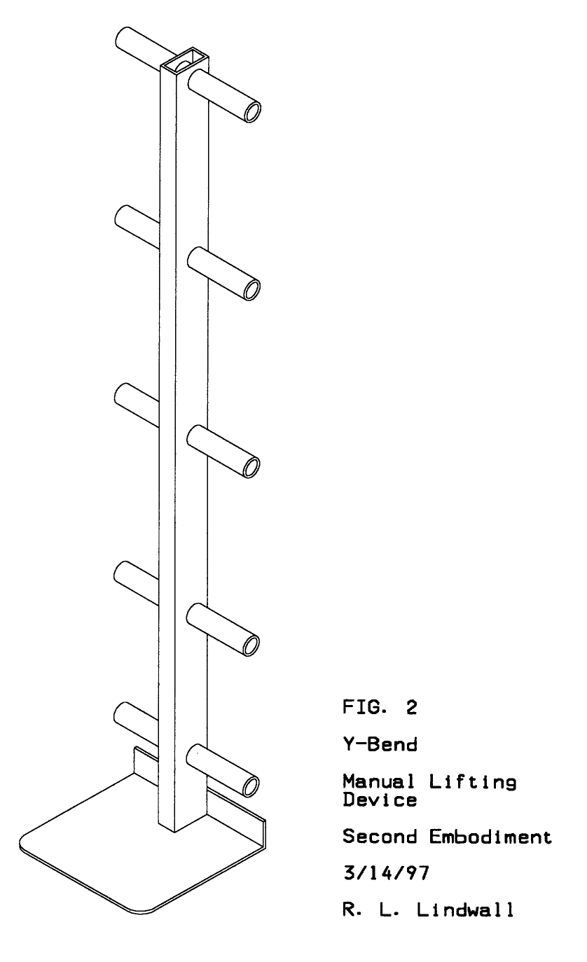

FIG. 3 is a photograph showing a prototype of the Y-Bend First Embodiment.

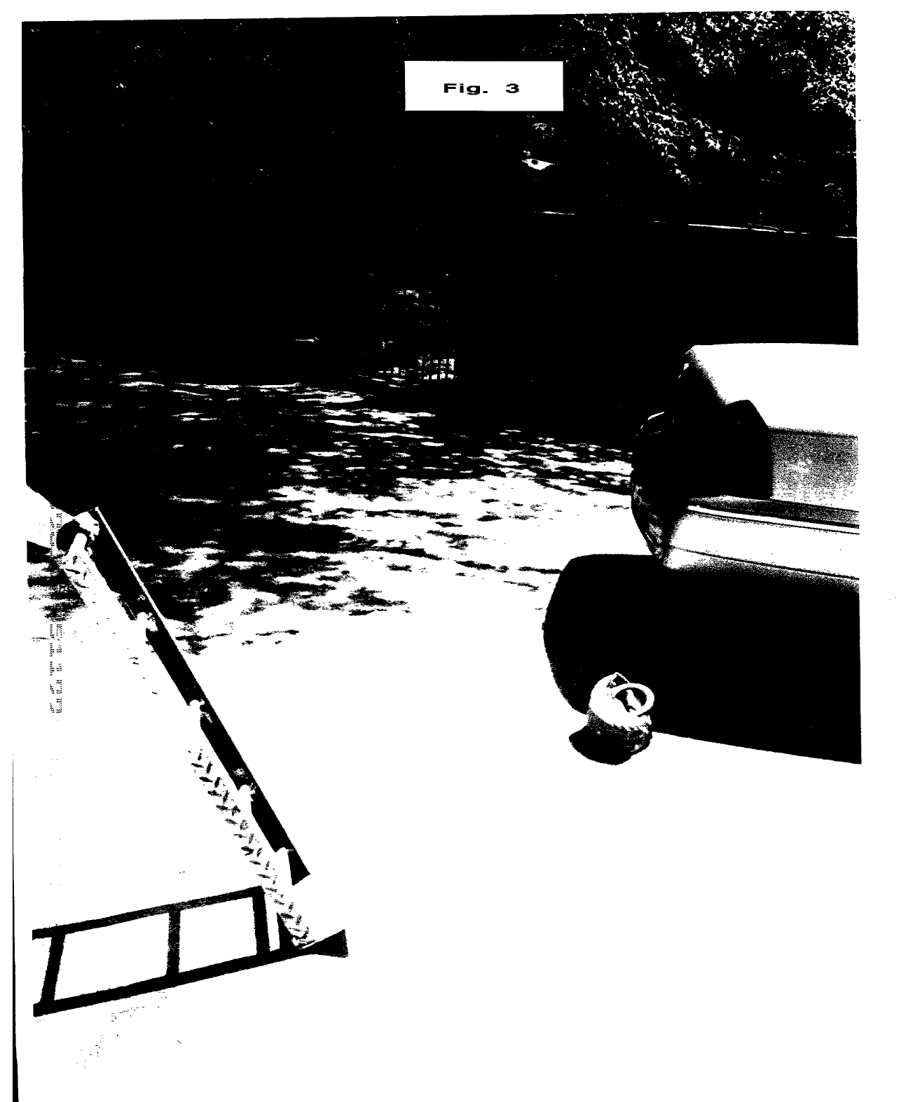

FIG. 4 is a photograph demonstrating the proper initial positioning of the Y-Bend First Embodiment.

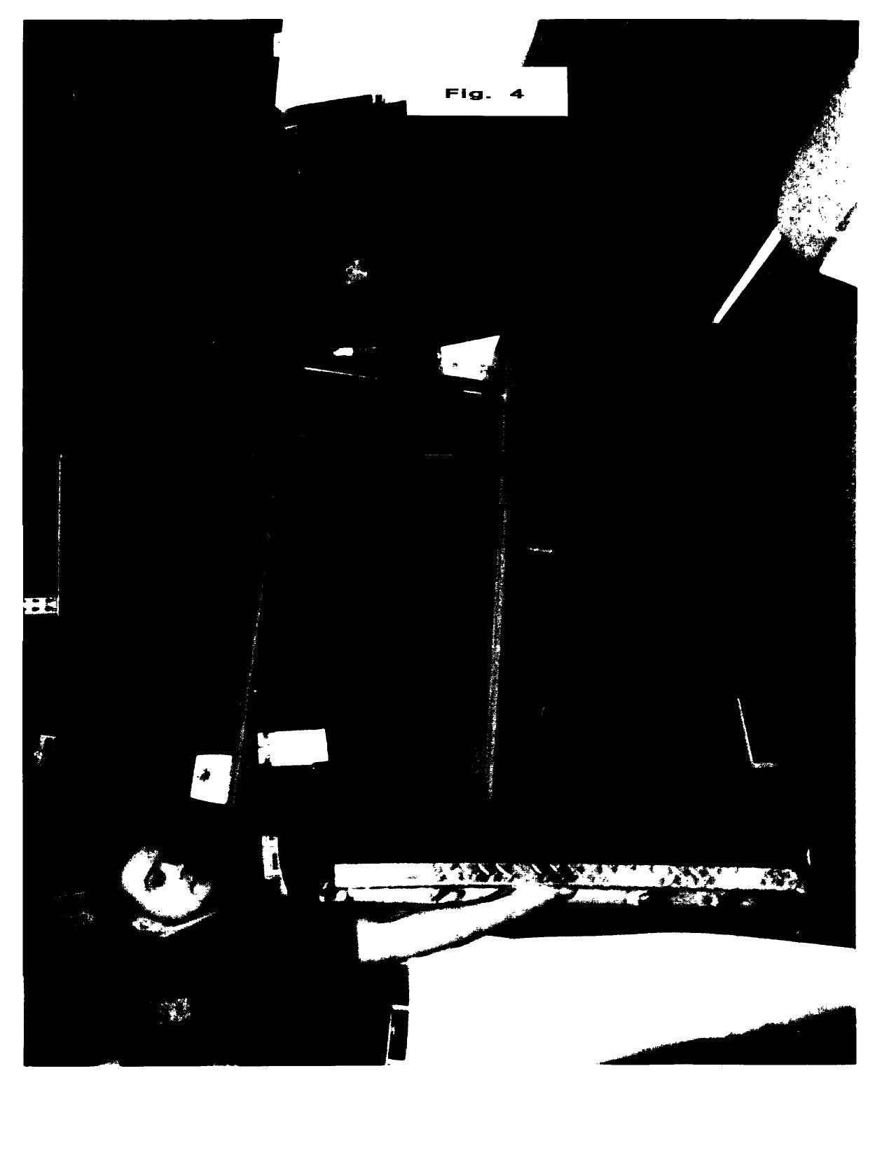

FIG. 5 is a photograph demonstrating the proper elevated positioning of the Y-Bend First Embodiment.

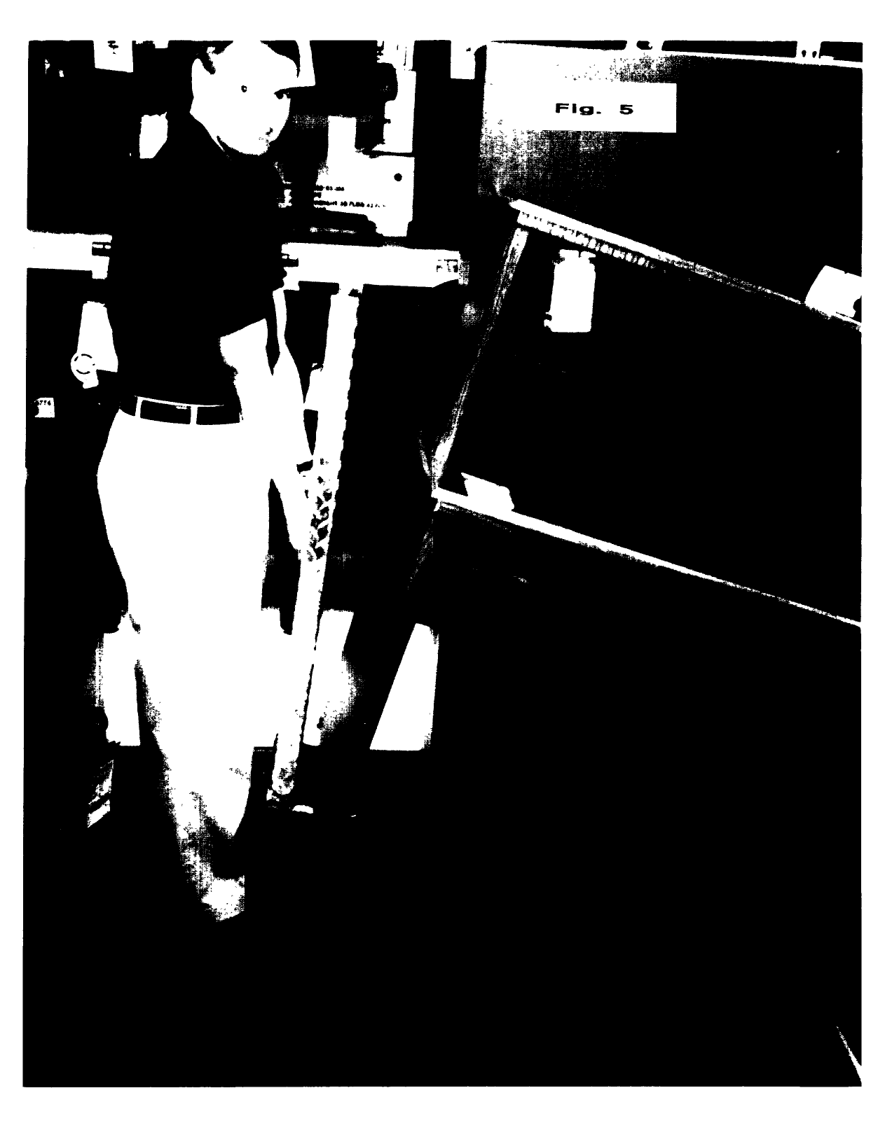

### DETAILED DESCRIPTION OF THE INVENTION

The Y-Bend combines the rails and rungs of a ladder with the “lip” of a hand truck to create a manual lifting device. The channel rails of the First Embodiment are attached to hollow rungs and a “lip” utilizing strong but light weight materials. The Y-Bend facilitates the elevation of heavy objects by unimpaired workers applying accepted principles of maximum utilization of the human anatomical structure.

What I claim as my invention is the y-bend:

1. An ergonomically correct manual lifting device comprising:
(a) an “L” shaped structure utilizing hand rungs and a lower lip to minimize back injury while elevating heavy objects such as office furniture,
(b) desks, filing cabinets, furniture, shipping boxes and other objects can be easily maneuvered while keeping the spine upright,
(c) an object can be elevated by walking the hands down the rungs of said device causing the load bearing lower lip and said object to become elevated,
(d) whereby unimpaired workers applying accepted principles of maximum utilization of the human anatomical structure are placed at substantially reduced risk of back injury while lifting with this device.
